(19) United States
(12) Patent Application Publication
(10) Pub. No.: US 2024/0055700 A1
(43) Pub. Date: Feb. 15, 2024

(54) ENERGY STORAGE APPARATUS

(71) Applicant: GS Yuasa International Ltd., Kyoto (JP)

(72) Inventors: Kazuya OKABE, Kyoto (JP); Ryoichi OKUYAMA, Kyoto (JP)

(73) Assignee: GS Yuasa International Ltd., Kyoto (JP)

(21) Appl. No.: 18/267,447

(22) PCT Filed: Dec. 2, 2021
(86) PCT No.: PCT/JP2021/044235

§ 371 Date: Jun. 14, 2023

(30) Foreign Application Priority Data
Dec. 16, 2020 (JP) 2020-208540

(51) Int. Cl. H01M 10/658; H01M 50/24; H01M 50/249

(52) U.S. Cl. CPC H01M 10/658; H01M 50/24; H01M 50/249; H01M 2220/20

(57) ABSTRACT

An energy storage apparatus includes an energy storage unit including a first energy storage device and a second energy storage device that are arranged in a first direction. The first energy storage device includes a concave part in which a surface of the first energy device, the surface opposite to the second energy storage device is recessed. The energy storage unit further includes: a first adhesive body that is disposed in the concave part between the first energy storage device and the second energy storage device and adheres to the first energy storage device and the second energy storage device; and a spacer that is disposed between the first energy storage device and the second energy storage device at a position different from the first adhesive body in a second direction intersecting with the first direction.

### TECHNICAL FIELD

The present invention relates to an energy storage apparatus including a plurality of energy storage devices.

### BACKGROUND ART

Conventionally, an energy storage apparatus having a configuration in which a plurality of energy storage devices is arranged side by side is widely known. For example, Patent Document 1 discloses a secondary battery device (energy storage apparatus) in which a plurality of battery cells (energy storage devices) is arranged and bonded with an adhesive or the like.

### PRIOR ART DOCUMENT

### Patent Document

Patent Document 1: JP-A-2013-251241

### SUMMARY OF THE INVENTION

### Problems to be Solved by the Invention

In the energy storage apparatus having the above-described conventional configuration, vibration resistance or impact resistance is not sometimes improved. For example, in Patent Document 1 described above, the plurality of energy storage devices (battery cells) are bonded to each other with the adhesive while a lower case is interposed therebetween. However, in general, a thickness of the adhesive between the energy storage devices is reduced in order to reduce a distance between the energy storage devices to be advantageous to miniaturization of the energy storage apparatus. Thus, because adhesive strength between the energy storage devices is not sufficient, the energy storage devices cannot be firmly bonded to each other, and the vibration resistance or the impact resistance of the energy storage apparatus cannot be sometimes improved.

The present invention has been made by the inventor of the present application focusing on the above problems, and an object of the present invention is to provide an energy storage apparatus capable of improving the vibration resistance or the impact resistance.

### Means for Solving the Problems

In order to achieve the above object, an energy storage apparatus according to one aspect of the present invention is an energy storage apparatus comprising an energy storage unit including a first energy storage device and a second energy storage device that are arranged in a first direction, in which the first energy storage device includes a concave part in which a surface of the first energy device, the surface opposite to the second energy storage device is recessed, and the energy storage unit further includes: a first adhesive body that is disposed in the concave part and adheres to the first energy storage device and the second energy storage device; and a spacer that is disposed between the first energy storage device and the second energy storage device, the spacer being disposed at a position different from a position of the first adhesive body in a second direction intersecting with the first direction.

Thus, in the energy storage apparatus, the energy storage unit includes the first adhesive body disposed in the concave part where the surface of the first energy storage device opposite to the second energy storage device is recessed and the spacer disposed at the position different from the position of the first adhesive body between the first energy storage device and the second energy storage device. In this manner, a thickness of the first adhesive body can be increased when the first adhesive body is disposed in the concave portion of the first energy storage device, and a thickness of the first adhesive body can be further increased when the spacer is disposed at the position different from the position of the first adhesive body. In particular, when the spacer is disposed between the first energy storage device and the second energy storage device, the first adhesive body can be prevented from being compressed and becoming thin, and the thickness of the first adhesive body can be maintained in a thick state. With such a configuration, the adhesive strength between the first energy storage device and the second energy storage device is improved, so that the vibration resistance or the impact resistance of the energy storage apparatus can be improved.

### Advantages of the Invention

According to the energy storage apparatus of the present invention, the vibration resistance or the impact resistance can be improved.

### BRIEF DESCRIPTION OF THE DRAWINGS

FIG. 1 is a perspective view illustrating an appearance of an energy storage apparatus according to an embodiment.

FIG. 2 is an exploded perspective view illustrating each component when the energy storage apparatus of the embodiment is disassembled.

FIG. 3 is a perspective view illustrating a configuration of an energy storage device of the embodiment.

FIG. 4 is a perspective view and a sectional view illustrating a concave part formed in a case of the energy storage device of the embodiment.

FIG. 5 is a front view illustrating a configuration in which a spacer and a first adhesive body are disposed on the energy storage device of the embodiment.

FIG. 6 is a sectional view illustrating configurations of adhesion of the energy storage devices in an energy storage unit and adhesion of the energy storage unit in an outer case of the embodiment.

FIG. 7 is a sectional view illustrating the configurations of the adhesion of the energy storage devices in the energy storage unit and the adhesion of the energy storage unit in the outer case of the embodiment.

FIG. 8 is a front view illustrating a configuration in which a spacer and a first adhesive body are disposed on an energy storage device according to a first modification of the embodiment.

FIG. 9 is a sectional view illustrating a configuration of a first adhesive body according to a second modification of the embodiment.

FIG. 10 is a sectional view illustrating a configuration of a first adhesive body according to a third modification of the embodiment.

### MODE FOR CARRYING OUT THE INVENTION

An energy storage apparatus according to one aspect of the present invention is an energy storage apparatus comprising an energy storage unit including a first energy storage device and a second energy storage device that are arranged in a first direction, in which the first energy storage device includes a concave part in which a surface of the first energy device, the surface opposite to the second energy storage device is recessed, and the energy storage unit further includes: a first adhesive body that is disposed in the concave part and adheres to the first energy storage device and the second energy storage device; and a spacer that is disposed between the first energy storage device and the second energy storage device, the spacer being disposed at a position different from a position of the first adhesive body in a second direction intersecting with the first direction.

Thus, in the energy storage apparatus, the energy storage unit includes the first adhesive body disposed in the concave part where the surface of the first energy storage device opposite to the second energy storage device is recessed and the spacer disposed at the position different from the position of the first adhesive body between the first energy storage device and the second energy storage device. In this manner, a thickness of the first adhesive body can be increased when the first adhesive body is disposed in the concave part of the first energy storage device, and a thickness of the first adhesive body can be further increased when the spacer is disposed at the position different from the position of the first adhesive body. In particular, when the spacer is disposed between the first energy storage device and the second energy storage device, the first adhesive body can be prevented from being compressed and becoming thin, and the thickness of the first adhesive body can be maintained in a thick state. With such a configuration, the adhesive strength between the first energy storage device and the second energy storage device is improved, so that the vibration resistance or the impact resistance of the energy storage apparatus can be improved.

The spacer may include adhesive layers that are adhered to the first energy storage device or the second energy storage device on both sides in the first direction.

Thus, the spacer includes the adhesive layers that adhered to the first energy storage device and the second energy storage device on both surfaces of the spacer. In this manner, when the spacer is adhered to the first energy storage device and the second energy storage device, the first energy storage device and the second energy storage device are fixed with the spacer interposed therebetween. Thus, the first energy storage device and the second energy storage device can be more firmly fixed by the adhesion using the first adhesive body and the adhesion using the spacer, so that the vibration resistance or the impact resistance of the energy storage apparatus can be improved.

The concave part may be formed such that a middle portion in the second direction of the surface of the first energy storage device is recessed.

Thus, the first adhesive body is disposed in the concave part formed in the middle portion of the surface opposite to the second energy storage device in the first energy storage device. In this manner, when the first adhesive body is disposed in the concave part of the middle portion of the first energy storage device, the first energy storage device and the second energy storage device are adhered to in a well-balanced manner, so that the vibration resistance or the impact resistance of the energy storage apparatus can be improved.

The energy storage unit may further include: an end member disposed at a position where the first energy storage device is sandwiched between the end member and the second energy storage device in the first direction; and a second adhesive body that is disposed between the end member and the first energy storage device and adheres to the end member and the first energy storage device.

Thus, the energy storage unit includes the end member and the second adhesive body adhering to the end member and the first energy storage device. In this manner, when the end member and the first energy storage device are adhered using the second adhesive body, the movement of the first energy storage device with respect to the end member is prevented, so that the vibration resistance or the impact resistance of the energy storage apparatus can be improved.

The energy storage apparatus may further include: an outer case accommodating the energy storage unit; and a fixing member fixing the energy storage unit and the outer case.

Thus, the fixing member that fixes the energy storage unit and the outer case is disposed. In this manner, when the energy storage unit and the outer case are fixed using the fixing member, movement of the energy storage unit (the first energy storage device and the second energy storage device) in the outer case is prevented, so that the vibration resistance or the impact resistance of the energy storage apparatus can be improved.

The first adhesive body may include a heat insulating material inside.

Thus, the first adhesive body includes the heat insulating material inside, so that the heat insulating material can be fixed together with the first energy storage device and the second energy storage device. Thus, even when the heat insulation member is disposed between the first energy storage device and the second energy storage device, the vibration resistance or the impact resistance of the energy storage apparatus can be improved.

Hereinafter, an energy storage apparatus according to an embodiment (including a modification of the present invention) will be described with reference to the drawings. The embodiment described below illustrates a comprehensive or specific example. Numerical values, shapes, materials, components, dispositions and connection forms of the components, manufacturing processes, order of the manufacturing processes, and the like described in the following embodiment are merely examples, and are not intended to limit the present invention. In each of the drawings, dimensions and the like are not strictly illustrated. In the drawings, the same or similar components are denoted by the same reference signs.

In the following description and drawings, an arrangement direction of a plurality of energy storage devices, an arrangement direction of a pair of end members, an arrangement direction of the energy storage device and the end member, an opposing direction of a pair of long side surfaces in a case of one energy storage device, or a thickness direction of the energy storage device or the end member is defined as an X-axis direction. The arrangement direction of a pair of electrode terminals in one energy storage device, or the opposing direction of a pair of short side surfaces in the case of the energy storage device is defined as a Y-axis direction. The alignment direction of an outer case body and an outer case lid of the energy storage apparatus, the alignment direction of a case body and a case lid of the energy storage device, the alignment direction of the energy storage device and a bus bar, or a vertical direction is defined as a Z-axis direction. The X-axis direction, the Y-axis direction, and the Z-axis direction are directions intersecting one another (orthogonal to one another in the embodiment). Although it may be conceivable that the Z-axis direction is not in the vertical direction depending on a mode of use, hereinafter the Z-axis direction is described as the vertical direction for convenience of explanation.

In the following description, an X-axis positive direction indicates an arrow direction of the X-axis, and an X-axis negative direction indicates an opposite direction to the X-axis positive direction. The same applies to the Y-axis direction and the Z-axis direction. In addition, hereinafter, the X-axis direction is also sometimes referred to as a first direction, and a direction intersecting the first direction (a Y-axis direction, a Z-axis direction, or the like orthogonal to the X-axis direction) is also sometimes referred to as a second direction. An expression indicating a relative direction or a posture such as parallel and orthogonal strictly also includes the case where the expression is not the direction or the posture. For example, two directions orthogonal to each other means not only that the two directions are completely orthogonal to each other, but also that the two directions are substantially orthogonal to each other, namely, includes a difference of, for example, about several percent.

### Embodiment

[1 General Description of Energy Storage Apparatus 10]

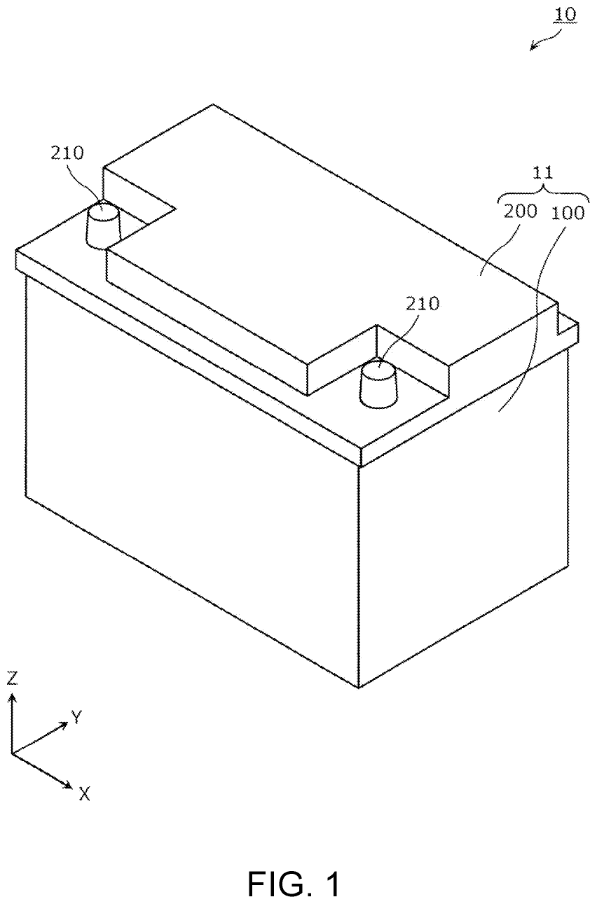

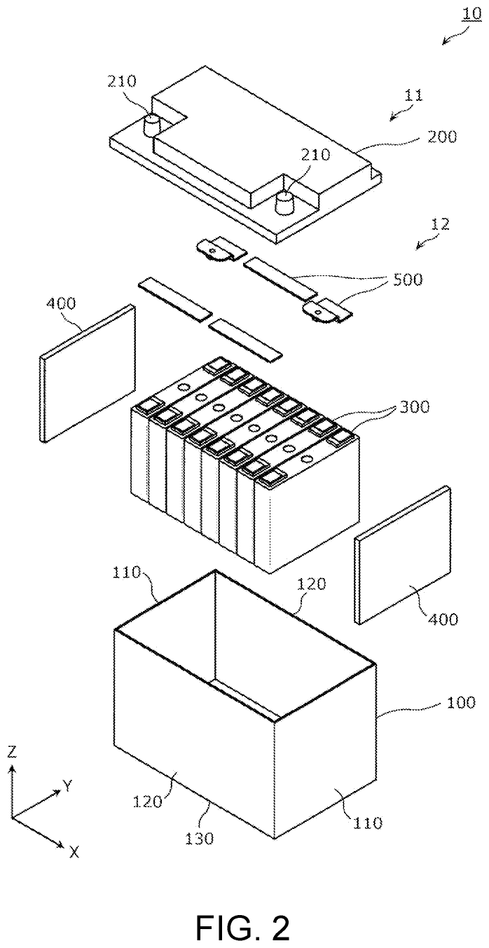

First, a configuration of an energy storage apparatus 10 will be described in detail. FIG. 1 is a perspective view illustrating an appearance of the energy storage apparatus 10 according to an embodiment. FIG. 2 is an exploded perspective view illustrating each component when the energy storage apparatus 10 of the embodiment is disassembled.

The energy storage apparatus 10 is an apparatus capable of charging electricity from the outside and discharging electricity to the outside, and has a substantially rectangular parallelepiped shape in the embodiment. The energy storage apparatus 10 is a battery module (assembled battery) used for a power storage application, a power supply application, and the like. Specifically, for example, the energy storage apparatus 10 is used as a battery for driving a moving body such as automobiles, motorcycles, watercrafts, vessels, snowmobiles, agricultural machines, construction machines, and railway vehicles for electric railway or starting an engine. Examples of the automobiles include an electric vehicle (EV), a hybrid electric vehicle (HEV), a plug-in hybrid electric vehicle (PHEV), and a gasoline automobile. Examples of the railway vehicle for the electric railway include a train, a monorail, a linear motor car, and a hybrid train including both a diesel engine and an electric motor. The energy storage apparatus 10 can also be used as a stationary battery or the like used for home use, business use, or the like.

As illustrated in FIG. 1, the energy storage apparatus 10 includes an outer case 11. As illustrated in FIG. 2, an energy storage unit 12 including a plurality of energy storage devices 300, a pair of end members 400, and a plurality of bus bars 500 is accommodated in the inside of the outer case 11. The energy storage apparatus 10 (energy storage unit 12) may include a bus bar frame that positions the bus bars 500, a circuit board that monitors a charged state and a discharged state of the energy storage devices 300, and electric equipment such as a relay in addition to the above-described components.

The outer case 11 is a rectangular (substantially rectangular parallelepiped shape) case (module case) configuring an enclosure (outer shell) of the energy storage apparatus 10. The outer case 11 is disposed outside the plurality of energy storage devices 300, the pair of end members 400, and the plurality of bus bars 500. The outer case 11 fixes the energy storage devices 300 and the like at predetermined positions and protects the energy storage devices 300 and the like from impact and the like. For example, the outer case 11 is formed of an insulating member such as polycarbonate (PC), polypropylene (PP), polyethylene (PE), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene perfluoroalkyl vinyl ether (PFA), polytetrafluoroethylene (PTFE), polyether sulfone (PES), an ABS resin, or a composite material thereof. This enables the outer case 11 to prevent the energy storage device 300 and the like from contacting with a metal member of the outside and the like. The outer case 11 may be formed by a conductive member such as metal as long as an electrical insulation property of the energy storage device 300 and the like is maintained.

The outer case 11 includes an outer case body 100 configuring a body of the outer case 11 and an outer case lid 200 configuring a lid of the outer case 11. The outer case body 100 is a bottomed rectangular cylindrical housing (enclosure) in which an opening directed in the Z-axis positive direction is formed, and accommodates the energy storage device 300 and the like. The outer case body 100 includes a pair of short side wall portions 110 that are opposite to each other on side surfaces thereof on both sides in the X-axis direction, a pair of long side wall portions 120 that are opposite to each other on side surfaces thereof on both sides in the Y-axis direction, and a bottom wall portion 130 that is disposed on the Z-axis negative direction side. Depending on the number, shape and the like of the energy storage devices 300, the outer case body 100 may have a pair of long side wall portions on both side surfaces in the X-axis direction and a pair of short side wall portions on both side surfaces in the Y-axis direction.

The short side wall portion 110 is a rectangular and flat plate-like wall portion that forms a short side surface of the outer case 11, and is disposed opposite to the end member 400 in the X-axis direction. The short side wall portion 110 is adjacent to the long side wall portion 120 and the bottom wall portion 130. The short side wall portion 110 is a wall portion in which an outer surface area is smaller than that of the long side wall portion 120. The long side wall portion 120 is a rectangular and flat plate-like wall portion that forms a long side surface of the outer case 11, and is disposed opposite to a short side surface portion 312 of a case 310 of the energy storage device 300 described later in the Y-axis direction. The long side wall portion 120 is adjacent to the short side wall portion 110 and the bottom wall portion 130. The long side wall portion 120 is a wall portion in which the outer surface area is larger than that of the short side wall portion 110. The bottom wall portion 130 is a rectangular and flat plate-like wall portion that forms a bottom surface of the outer case 11, and is disposed opposite to a bottom surface portion 313 of the later-described case 310 of the energy storage device 300 in the Z-axis direction. The bottom wall portion 130 is a wall portion adjacent to the short side wall portion 110 and the long side wall portion 120.

The outer case lid 200 is a flat rectangular member that closes the opening of the outer case body 100 by being joined to the outer case body 100 by heat sealing or the like. A pair of external terminals 210 (a positive electrode external terminal and a negative electrode external terminal) of a positive electrode and a negative electrode is provided in the outer case lid 200. The energy storage apparatus 10 charges electricity from the outside and discharges electricity to the outside through the pair of external terminals 210. The outer case body 100 and the outer case lid 200 may be made of a member of the same material or made of members of different materials.

The energy storage device 300 is a secondary battery (battery cell) capable of charging and discharging electricity, more specifically, a nonaqueous electrolyte secondary battery such as a lithium-ion secondary battery. In the embodiment, the energy storage device 300 has a flat, rectangular parallelepiped (prismatic) shape, and eight energy storage devices 300 are arrayed in the X-axis direction (first direction). The shape of the energy storage device 300 is not limited to the rectangular parallelepiped shape, but may be an elongated columnar shape, a polygonal columnar shape other than a rectangular parallelepiped shape, or the like. The number of the arrayed energy storage devices 300 is not particularly limited as long as it is two or more. The energy storage device 300 is not limited to a nonaqueous electrolyte secondary battery but may be a secondary battery except for the nonaqueous electrolyte secondary battery or a capacitor. The energy storage device 300 is not the secondary battery but may be a primary battery that can use stored electricity without being charged by a user. The energy storage device 300 may be a battery in which a solid electrolyte is used. The energy storage device 300 may be a pouch type energy storage device. Details of the configuration of the energy storage device 300 will be described later.

The end members 400 are flat and rectangular members (sandwiching members) that are disposed on both sides in the X-axis direction of the plurality of energy storage devices 300. The end members 400 sandwich and hold the plurality of energy storage devices 300 from both sides in the array direction (X-axis direction) of the plurality of energy storage devices 300. With such a configuration, the pair of end members 400 press the plurality of energy storage devices 300 from both sides in the array direction (X-axis direction) of the plurality of energy storage devices 300. For example, the end member 400 is formed of a metal (conductive) material such as stainless steel, iron, a plated steel plate, or an aluminum alloy from a viewpoint of securing strength. The material of the end member 400 is not particularly limited, but for example, may be formed of an electrically insulating material having high strength, or subjected to an insulation treatment. The shape of the end member 400 is also not particularly limited, but may be a plate-like member (corrugated plate or the like) having irregularities, a block-like member, or the like.

The bus bar 500 is a rectangular-shaped flat-plate-like member that is disposed above the plurality of energy storage devices 300 and connected to later-described electrode terminals 340 (a positive electrode terminal and a negative electrode terminal) of the plurality of energy storage devices 300. With such a configuration, the bus bar 500 connects the electrode terminals 340 of the plurality of energy storage devices 300, and connects the electrode terminals 340 of the energy storage devices 300 of the end and the external terminals 210 through other bus bars (not illustrated). The bus bar 500 is made of a metal conductive member such as copper, a copper alloy, aluminum, and an aluminum alloy. In the embodiment, the bus bar 500 configures four sets of energy storage device groups by connecting two energy storage devices 300 in parallel and connects the four sets of energy storage device groups in series, but a connection form of the energy storage devices 300 is not particularly limited.

[2 Description of Energy Storage Device 300]

The configuration of the energy storage device 300 will be described in detail. Because all the energy storage devices 300 included in the energy storage unit 12 have the same configuration, the configuration of one energy storage device 300 will be described in detail below.

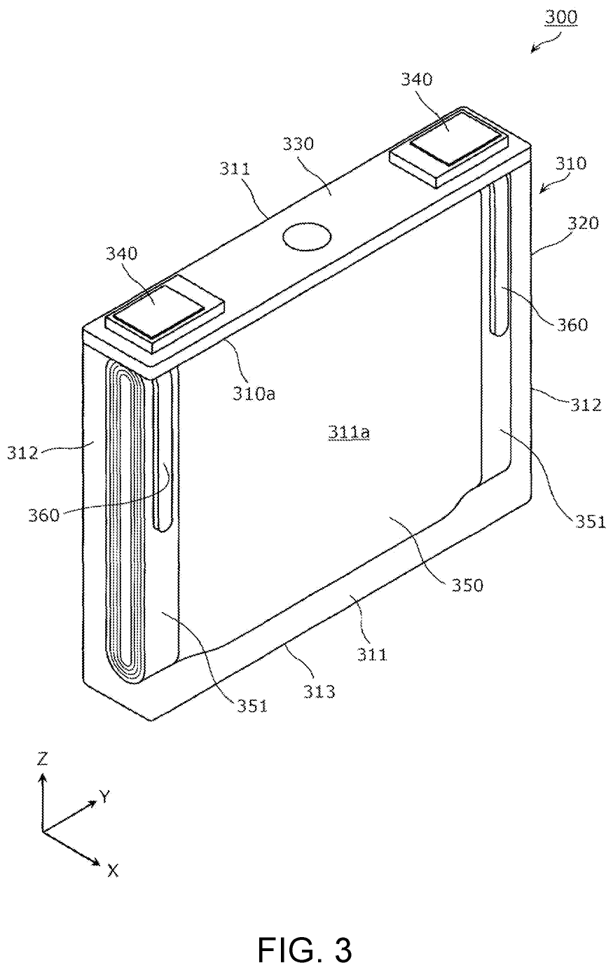

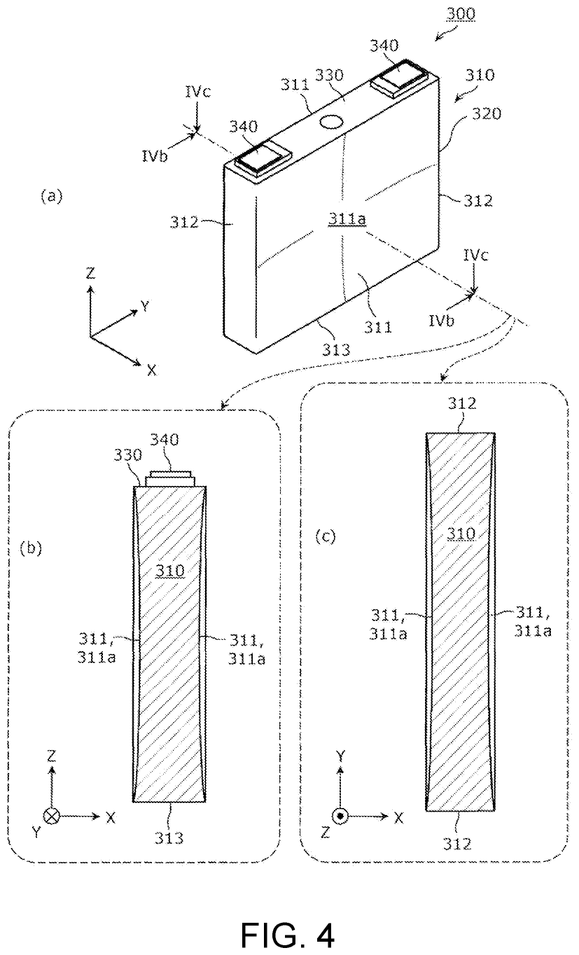

FIG. 3 is a perspective view illustrating the configuration of the energy storage device 300 of the embodiment. Specifically, FIG. 3 illustrates the internal configuration of the case 310 of the energy storage device 300 in a transparent manner. FIG. 4 is a perspective view and a sectional view illustrating a concave part 311a formed in the case 310 of the energy storage device 300 of the embodiment. Specifically, (a) of FIG. 4 is a perspective view illustrating an appearance of the case 310. (b) of FIG. 4 is a sectional view illustrating a configuration in the case where (a) of FIG. 4 is cut along a line IVb-IVb. Namely, (b) of FIG. 4 is a sectional view illustrating a configuration in the case where (a) of FIG. 4 is cut along a plane that passes through a center position of the case 310 and is parallel to an XZ-plane. (c) of FIG. 4 is a sectional view illustrating a configuration in the case where (a) of FIG. 4 is cut along a line IVc-IVc, Namely, (c) of FIG. 4 is a sectional view illustrating a configuration in the case where (a) of FIG. 4 is cut along a plane that passes through the center position of the case 310 and is parallel to an XY-plane.

As illustrated in FIG. 3, the energy storage device 300 includes the case 310 and the pair of electrode terminals 340 (the positive electrode and the negative electrode), and an electrode assembly 350 and a pair of current collectors 360 (a positive electrode and a negative electrode) are accommodated in the case 310. An electrolyte solution (nonaqueous electrolyte) is sealed in the case 310, and a gasket is disposed between the electrode terminal 340 and the case 310 (a case lid 330 described later) and between the current collector 360 and the case 310 (a case lid 330 described later), but their detailed descriptions are omitted. A kind of the electrolyte solution is not particularly limited as long as performance of the energy storage device 300 is not impaired, and various kinds of electrolyte solutions can be selected.

In addition to the above-described components, the energy storage device 300 may include a spacer disposed on a side, a lower side, or the like of the electrode assembly 350, an insulating film enclosing the electrode assembly 350 and the like, and the like. The insulating film (such as a shrink tube) that covers the outer surface of the case 310 may be disposed around the case 310. The material of the insulating film is not particularly limited as long as it can secure the electrical insulation property required for the energy storage device 300, and examples of the material include electrically insulating resins such as PC, PP, PE, PPS, PET, PBT and ABS resins, epoxy resins, Kapton, Teflon (registered trademark), silicone, polyisoprene, and polyvinyl chloride.

The case 310 is a rectangular parallelepiped (square or box shape) case including a case body 320 in which the opening is formed and the case lid 330 that closes the opening of the case body 320. The case body 320 is a member configuring a body of the case 310. The case body 320 includes a bottom and has a rectangular cylindrical shape, and the opening is formed on the Z-axis positive direction side. The case lid 330 is a rectangular plate-like member configuring the lid of the case 310, and is disposed to extend in the Y-axis direction on the Z-axis positive direction side of the case body 320. The case lid 330 is provided with a gas release valve that releases pressure when the pressure in the case 310 increases, an injection unit (not illustrated) that injects the electrolyte solution in the case 310, and the like. The material of the case 310 (the case body 320 and the case lid 330) is not particularly limited. The material of the case 310 may be weldable (joinable) metal such as stainless steel, aluminum, an aluminum alloy, iron, or a plated steel plate, and resin can also be used.

After the electrode assembly 350 and the like are accommodated in the inside of the case body 320, the case body 320 and the case lid 330 are joined to each other by welding or the like to form a joint portion 310a, whereby the inside of the case 310 is sealed. The case 310 has a pair of long side surface portions 311 on side surfaces on both sides in the X-axis direction, a pair of short side surface portions 312 on side surfaces on both sides in the Y-axis direction, and a bottom surface portion 313 on the Z-axis negative direction side.

The long side surface portion 311 is a rectangular flat surface portion that forms a long side surface of the case 310, and is disposed opposite to the long side surface portion 311 of the case 310 of the adjacent energy storage device 300 or the end member 400 in the X-axis direction. The long side surface portion 311 is adjacent to the short side surface portion 312 and the bottom surface portion 313, and has the area larger than that of the short side surface portion 312. The short side surface portion 312 is a rectangular flat surface portion that forms a short side surface of the case 310, and is disposed opposite to the long side wall portion 120 of the outer case 11 in the Y-axis direction. The short side surface portion 312 is adjacent to the long side surface portion 311 and the bottom surface portion 313, and has the area smaller than that of the long side surface portion 311. The bottom surface portion 313 is a rectangular flat surface portion that forms the bottom surface of the case 310. The bottom surface portion 313 is opposite to the bottom wall portion 130 of the outer case 11 in the Z-axis direction, and is disposed adjacent to the long side surface portion 311 and the short side surface portion 312.

The concave part 311a is formed in the long side surface portion 311 of the case 310. In the embodiment, the concave part 311a is formed in each of the pair of long side surface portions 311 of the case 310. As illustrated in FIG. 4, the concave part 311a is a concave in which the long side surface portion 311 is recessed in a curved shape toward the inside of the case 310 in the X-axis direction. The case 310 is gradually recessed in the X-axis direction from the ends (the outer peripheral portion of the long side surface portion 311 as viewed in the X-axis direction) in the Y-axis direction and the Z-axis direction of the long side surface portion 311 toward the middle portion of the long side surface portion 311, so that the middle portion of the long side surface portion 311 (particularly, the center position) has the most concave shape.

As described above, the concave part 311a is a concave which is formed by recessing the middle portion of the long side surface portion 311 of the energy storage device 300 in the direction intersecting (orthogonal to) with the X-axis direction. A concave amount (a depth in the X-axis direction) of the concave part 311a in the middle portion (the center position of the long side surface portion 311) of the long side surface portion 311 is not particularly limited, but is preferably about 0.5 mm to 1.5 mm, and more preferably about 1 mm. For example, the concave part 311a can be formed by the following method. When the electrolyte solution is injected into the case 310, air may remain in the gap in the electrode assembly 350, and the electrolyte solution may hardly permeate the electrode assembly 350. In particular, in the large-sized energy storage device 300, air tends to remain in the gap in the electrode assembly 350. In order to remove the air remaining in the case 310, CO₂ substitution is performed during manufacturing of the energy storage device 300. Thereafter, the substituted CO₂ is absorbed by the negative electrode, and the inside of the case 310 has a negative pressure by charging and discharging the energy storage device 300. When the inside of the case 310 has the negative pressure, the long side surface portion 311 of the case 310 is recessed, and the concave part 311a can be formed.

The electrode terminals 340 are terminal members (the positive electrode terminal and the negative electrode terminal) of the energy storage device 300 disposed on the case lid 330, and are electrically connected to the positive electrode plate and the negative electrode plate of the electrode assembly 350 through the current collector 360. The electrode terminal 340 is a metal member that leads out electricity stored in the electrode assembly 350 to a space outside the energy storage device 300 and introduces electricity into a space inside the energy storage device 300 in order to store electricity in the electrode assembly 350. The electrode terminal 340 is made of aluminum, an aluminum alloy, copper, a copper alloy, or the like.

The electrode assembly 350 is an energy storage element (power generating element) that can store electricity, includes the positive electrode plate, the negative electrode plate, and the separator, and is formed by stacking the positive electrode plate, the negative electrode plate, and the separator. The positive electrode plate is an electrode plate that is obtained by forming a positive active material layer on a positive electrode base material layer that is a strip-shaped current collecting foil made of metal such as aluminum or an aluminum alloy. The negative electrode plate is an electrode plate that is obtained by forming a negative active material layer on a negative electrode base material layer that is a strip-shaped current collecting foil made of metal such as copper or a copper alloy. The separator is a microporous sheet made of resin. As the positive active material used for the positive active material layer and the negative active material used for the negative active material layer, a known material can be used as appropriate as long as the known material can charge and discharge lithium ions. For the separator, a known material can be used as appropriate as long as the known material does not impair the performance of the energy storage device 300.

That is, the electrode assembly 350 is a winding type electrode assembly that is formed by winding the positive electrode plate and the negative electrode plate that are arranged in a layered manner such that the separator is sandwiched between the positive electrode plate and the negative electrode plate. Specifically, in the electrode assembly 350, the positive electrode plate and the negative electrode plate are wound with the separator interposed therebetween while shifted from each other in a direction of a winding axis (Y-axis direction). Each of the positive electrode plate and the negative electrode plate includes a portion (mixture layer-non-formed portion) in which the mixture is not applied and the base material layer is exposed (the mixture layer is not formed) at an end 351 in each shifted direction. The electrode assembly 350 is electrically and mechanically connected to the current collector 360 at the end 351. The electrode assembly 350 may be formed by winding the positive electrode plate, the negative electrode plate, and the separator around the winding axis parallel to the Z-axis direction. The electrode assembly 350 may be an electrode assembly in any form such as a stacking-type electrode assembly formed by stacking a plurality of plate-shaped electrode plates or a bellows-type electrode assembly formed by folding plates in a bellows shape.

The current collector 360 is a member having conductivity and rigidity, disposed between the electrode assembly 350 and the side wall of the case 310, and electrically connected to the electrode terminal 340 and the electrode assembly 350. The current collector 360 is joined to the end 351 of the electrode assembly 350 by welding or the like. The positive electrode current collector 360 is formed of aluminum, an aluminum alloy or the like similarly to the positive electrode base material layer of the positive electrode plate of the electrode assembly 350. The negative electrode current collector 360 is formed of copper, a copper alloy, or the like similarly to the negative electrode base material layer of the negative electrode plate of the electrode assembly 350.

In the above-described configuration, in the inside of the outer case 11, the energy storage devices 300 adheres to the adjacent members (the other energy storage devices 300 or the other end members 400), and the energy storage unit 12 adheres to the adjacent member (outer case body 100). Specifically, the plurality of energy storage devices 300 and the end member 400 are fixed to each other by disposing an adhesive between the adjacent energy storage devices 300 among the plurality of energy storage devices 300 included in the energy storage unit 12 and between the energy storage device 300 at the end and the end member 400. The energy storage unit 12, the pair of short side wall portions 110, the pair of long side wall portions 120, and the bottom wall portion 130 of the outer case body 100 are fixed to each other by adhesion. These configurations will be described in detail below.

[3 Description of Adhesion Configuration of Energy Storage Devices 300 and Energy Storage Units 12 in Outer Case 11]

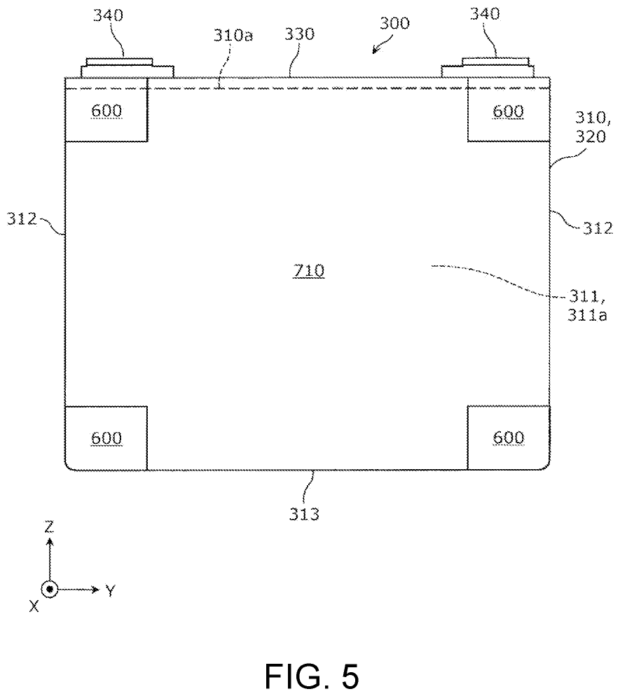

FIG. 5 is a front view illustrating a configuration in which a spacer 600 and a first adhesive body 710 are disposed on the energy storage device 300 of the embodiment.

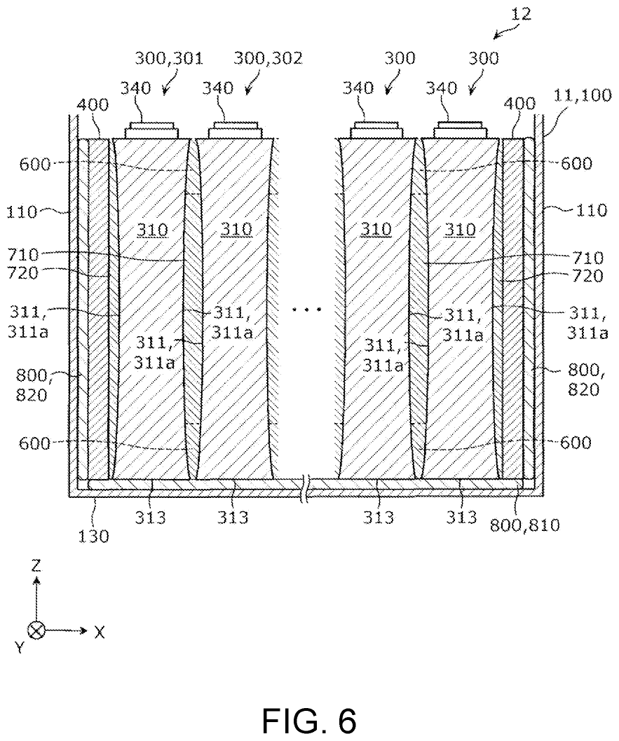

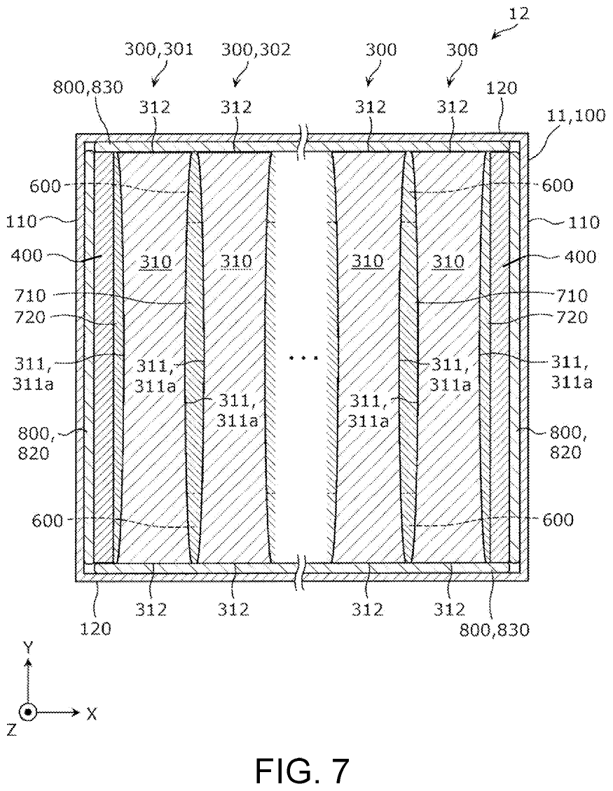

Specifically, FIG. 5 illustrates positions where the spacer 600 and the first adhesive body 710 are disposed when the state where the spacer 600 and the first adhesive body 710 are disposed on the energy storage device 300 is viewed from the X-axis positive direction. FIG. 6 and FIG. 7 are sectional views illustrating the configurations of the adhesion of the energy storage devices 300 in the energy storage unit 12 and the adhesion of the energy storage unit 12 in the outer case 11 of the embodiment. Specifically, FIG. 6 is the sectional view illustrating the configuration where the state where the energy storage unit 12 is disposed in the outer case body 100 of the outer case 11 is cut along the plane which passes through the center position of the energy storage unit 12 and is parallel to the XZ-plane. FIG. 7 is the sectional view illustrating the configuration when the state where the energy storage unit 12 is disposed in the outer case body 100 is cut along the plane which passes through the center position of the energy storage unit 12 and is parallel to the XY-plane.

As illustrated in FIG. 5 to FIG. 7, the energy storage unit 12 includes the spacer 600 and the first adhesive body 710 in addition to the above-described configurations. As illustrated in FIG. 6 and FIG. 7, between the long side surface portions 311 of two energy storage devices 300 disposed adjacently to each other, the spacer 600 and the first adhesive body 710 are disposed at positions in FIG. 5 on the long side surface portions 311 of the energy storage devices 300.

As illustrated in FIG. 6 and FIG. 7, among the plurality of energy storage devices 300, the energy storage device 300 positioned at the end in the X-axis negative direction is also referred to as a first energy storage device 301, and the energy storage device 300 adjacent to the first energy storage device 301 in the X-axis positive direction is also referred to as a second energy storage device 302. That is, the energy storage unit 12 includes the first energy storage device 301 and the second energy storage device 302 disposed in the X-axis direction (first direction). Because other energy storage devices 300 have the same configuration as the first energy storage device 301 and the second energy storage device 302, hereinafter, the description of the first energy storage device 301 and the second energy storage device 302 will be focused, and the description of the other energy storage devices 300 will be simplified or omitted.

As described above, the first energy storage device 301 includes the concave part 311a in which the long side surface portion 311 opposite to the second energy storage device 302 is recessed. The concave part 311a of the first energy storage device 301 is a concave that is formed by recessing the middle portion in the direction (second direction: the Z-axis direction in FIG. 6 and the Y-axis direction in FIG. 7) intersecting with the X-axis direction (orthogonal in the embodiment) of the long side surface portion 311 of the first energy storage device 301. Similarly, the second energy storage device 302 includes the concave part 311a in which the long side surface portion 311, which is the surface opposite to the first energy storage device 301, is recessed. The concave part 311a of the second energy storage device 302 is a concave formed by recessing the middle portion in the direction (second direction: the Z-axis direction in FIG. 6 and the Y-axis direction in FIG. 7) intersecting with the X-axis direction (orthogonal in the embodiment) of the long side surface portion 311 of the second energy storage device 302.

In such a configuration, the spacer 600 and the first adhesive body 710 are disposed between the first energy storage device 301 and the second energy storage device 302. Specifically, the spacer 600 and the first adhesive body 710 are disposed between the long side surface portion 311 of the first energy storage device 301 and the long side surface portion 311 of the second energy storage device 302.

The spacer 600 is a member that is disposed at the position different from the first adhesive body 710 in the direction (second direction) intersecting with (orthogonal to in the embodiment) the X-axis direction (first direction) between the first energy storage device 301 and the second energy storage device 302. That is, the spacer 600 is disposed at the position not overlapping the first adhesive body 710 as viewed in the X-axis direction. In the embodiment, as illustrated in FIG. 5, the spacer 600 is disposed at the end (an outer peripheral portion of the long side surface portion 311) of the long side surface portion 311 of the first energy storage device 301 (and the second energy storage device 302). Specifically, the spacers 600 are disposed at four corners (the ends on both sides in the Y-axis direction and the ends on both sides in the Z-axis direction) of the long side surface portion 311 of the first energy storage device 301 (and the second energy storage device 302). As described above, the spacer 600 is disposed at the position where the thickness of the first energy storage device 301 (and the second energy storage device 302) is thicker than that of the middle portion of the long side surface portion 311.

In the embodiment, the spacer 600 is a double-sided tape and has the electrical insulation property. That is, the spacer 600 includes adhesive layers made of a pressure sensitive adhesive, which are adhered to the first energy storage device 301 and the second energy storage device 302, on both sides in the X-axis direction (first direction). For example, the spacer 600 is the double-sided tape in which the adhesive layers are provided on both surfaces of the base material having the electrical insulation property, such as a rectangular plate-like resin having a thickness of about 1 mm.

The first adhesive body 710 is a member that is disposed in the concave part 311a between the first energy storage device 301 and the second energy storage device 302 and adheres to the first energy storage device 301 and the second energy storage device 302. That is, the first adhesive body 710 is disposed in the concave part 311a formed in the middle portion of the long side surface portion 311 of the first energy storage device 301 and in the concave part 311a formed in the middle portion of the long side surface portion 311 of the second energy storage device 302. The first adhesive body 710 is the adhesive and has the electrical insulation property in the embodiment. An adhesive that is in a liquid state before being injected (filled) into the concave part 311a and adheres by being in a solid state, an adhesive that is in a gel state before being injected (filled), or an adhesive that is in a solid state such as a hot melt adhesive can be used as the adhesive.

The first adhesive body 710 is disposed on the entire surface of a portion of the long side surface portion 311, the portion where the spacer 600 is not disposed. For example, after the first energy storage device 301 and the second energy storage device 302 are temporarily fixed by the spacer 600, the first adhesive body 710 is poured from a gap between the spacers 600 between the first energy storage device 301 and the second energy storage device 302. Accordingly, the first adhesive body 710 is poured (filled) into the entire portion where the spacer 600 is not disposed between the first energy storage device 301 and the second energy storage device 302. The first adhesive body 710 is also disposed on a portion (a portion where the spacer 600 is not disposed) of the long side surface portion 311 other than both ends in the Y-axis direction of the joint portion 310a.

In order to fix the energy storage unit 12 having the energy storage devices 300 and the outer case 11 (outer case body 100) to each other, as illustrated in FIG. 6 and FIG. 7, the energy storage apparatus 10 includes a second adhesive body 720 and a fixing member 800 (810, 820 and 830) in addition to the above-described configuration.

The second adhesive body 720 is a member that is disposed between the end member 400 and the energy storage device 300 and adheres to the end member 400 and the energy storage device 300. For example, the end member 400 in the X-axis negative direction is disposed at position where the first energy storage device 301 is sandwiched between the end member 400 and the second energy storage device 302 in the X-axis direction (first direction). The second adhesive body 720 adhering to the end member 400 and the first energy storage device 301 is disposed between the end member 400 and the first energy storage device 301. The same applies to the end member 400 in the X-axis positive direction. In the embodiment, the second adhesive body 720 is an adhesive and has electrical insulation property. Any adhesive or the like usable for the first adhesive body 710 can be used as the adhesive.

In the embodiment, the second adhesive body 720 is poured (filled) over the entire space (the entire surface of the long side surface portion 311) between the end member 400 and the energy storage device 300. That is, the second adhesive body 720 is disposed over the entire joint portion 310a of the long side surface portion 311. A member (double-sided tape or the like) similar to the spacer 600 may be disposed between the end member 400 and the energy storage device 300.

The fixing member 800 is a member disposed between the energy storage unit 12 and the outer case 11 and fixing the energy storage unit 12 and the outer case 11. Fixing members 810, 820 and 830 are disposed around (the bottom surface and the side surfaces) the energy storage unit 12 as the fixing member 800, and the energy storage unit 12 and the outer case body 100 of the outer case 11 are fixed to each other by the fixing members 810, 820 and 830. In the embodiment, the fixing members 800 (810, 820 and 830) are adhesive, and have the electrical insulation property. Any adhesive or the like usable for the first adhesive body 710 can be used as the adhesive.

The fixing member 810 is a member that is disposed between the bottom surface portion 313 of the case 310 of the energy storage device 300 included in the energy storage unit 12 and the bottom wall portion 130 of the outer case body 100 included in the outer case 11. The fixing member 810 fixes the bottom surface portion 313 and the bottom wall portion 130. In the embodiment, the fixing member 810 is disposed between the bottom surface portion 313 of the plurality of energy storage devices 300 and the bottom wall portion 130 and between the pair of end members 400 and the bottom wall portion 130 by coating or the like over one end member 400 of the pair of end members 400 to the other end member 400. The fixing member 810 fixes the bottom surface portions 313 of the plurality of energy storage devices 300 and the pair of end members 400 to the bottom wall portion 130 by the adhesion.

As described above, the fixing member 810 is disposed between the bottom surface of the energy storage unit 12 and the bottom wall portion 130 over the entire bottom surface in the Z-axis negative direction, and fixes the entire bottom surface and the bottom wall portion 130 by the adhesion. The fixing member 810 is disposed only on a part of the bottom surface of the energy storage unit 12 in the Z-axis negative direction, and the part of the bottom surface and the bottom wall portion 130 may be fixed by the adhesion.

The fixing member 820 is a member that is disposed between the end member 400 included in the energy storage unit 12 and the short side wall portion 110 of the outer case body 100 included in the outer case 11. The fixing member 820 fixes the end member 400 and the short side wall portion 110. In the embodiment, the fixing member 820 is disposed while injected (filled) between the end member 400 and the short side wall portion 110 over the entire surface opposite to the short side wall portion 110 in the end member 400, and the entire surface of the end member 400 and the short side wall portion 110 are fixed by the adhesion. In the embodiment, the pair of fixing members 820 is disposed between the pair of end members 400 and the pair of short side wall portions 110, and the pair of end members 400 and the pair of short side wall portions 110 are fixed.

As described above, the fixing member 820 is disposed between both side surfaces of the energy storage unit 12 in the X-axis direction and the pair of short side wall portions 110 over the entire surfaces of both the side surfaces of the energy storage unit 12 in the X-axis direction, and fixes the entire surfaces of both side surfaces and the pair of short side wall portions 110 by adhesion. The fixing member 820 is disposed only on a part of the side surface of the energy storage unit 12, and a part of the side surface and the short side wall portion 110 may be fixed by the adhesion.

The fixing member 830 is a member that is disposed between the short side surface portion 312 of the case 310 of the energy storage device 300 included in the energy storage unit 12 and the long side wall portion 120 of the outer case body 100 included in the outer case 11. The fixing member 830 fixes the short side surface portion 312 and the long side wall portion 120. In the embodiment, the fixing member 830 is disposed while injected (filled) between the short side surface portions 312 of the plurality of energy storage devices 300 and the long side wall portions 120 and between the pair of end members 400 and the long side wall portions 120 over one end member 400 of the pair of end members 400 to the other end member 400. The fixing member 830 fixes the short side surface portions 312 of the plurality of energy storage devices 300 and the pair of end members 400 to the long side wall portions 120 by the adhesion. In the embodiment, the pair of fixing members 830 is disposed between the pair of short side surface portions 312 and the like included in the case 310 of the energy storage device 300 and the pair of long side wall portions 120 of the outer case body 100, and the pair of short side surface portions 312 and the like and the pair of long side wall portions 120 are fixed.

As described above, the fixing member 830 is disposed between both the side surfaces of the energy storage unit 12 in the Y-axis direction and the pair of long side wall portions 120 over the entire surfaces of both the side surfaces of the energy storage unit 12 in the Y-axis direction, and fixes the entire surfaces of both the side surfaces and the pair of long side wall portions 120 by the adhesion. The fixing member 830 is disposed only on a part of the side surface of the energy storage unit 12, and a part of the side surface and the long side wall portion 120 may be fixed by the adhesion.

[4 Description of Effects]

According to the energy storage apparatus 10 of the embodiment, the energy storage unit 12 includes the first adhesive body 710 disposed in the concave part 311a where the long side surface portion 311 of the first energy storage device 301 is recessed and the spacer 600 disposed at the position different from the position of the first adhesive body 710 between the first energy storage device 301 and the second energy storage device 302. The thickness of the first adhesive body 710 can be increased when the first adhesive body 710 is disposed in the concave part 311a of the first energy storage device 301, and the thickness of the first adhesive body 710 can be further increased when the spacer 600 is disposed at the position different from the position of the first adhesive body 710. In particular, when the spacer 600 is disposed between the first energy storage device 301 and the second energy storage device 302, the first adhesive body 710 can be prevented from being compressed and becoming thin, and the thickness of the first adhesive body 710 can be maintained in a thick state. When the first energy storage device 301 is about to swell, stress peeling off the adhesion between the first energy storage device 301 and the second energy storage device 302 by the first adhesive body 710 is dispersed by disposing the first adhesive body 710 in the concave part 311a of the first energy storage device 301. Thus, peeling of the first energy storage device 301 and the second energy storage device 302 can be prevented. With such a configuration, the adhesive strength between the first energy storage device 301 and the second energy storage device 302 is improved, so that the vibration resistance or the impact resistance of the energy storage apparatus 10 can be improved.

When the concave part 311a is formed in the first energy storage device 301, frictional force between the inner surface of the case 310 of the first energy storage device 301 and the electrode assembly 350 is improved, so that the movement of the electrode assembly 350 in the case 310 is prevented. With such a configuration, the vibration resistance or the impact resistance of the energy storage apparatus 10 (the first energy storage device 301) can be improved.

Because both the first adhesive body 710 and the spacer 600 have the electrical insulation property, the electrical insulation properties of the first energy storage device 301 and the second energy storage device 302 can be improved. In particular, because the first adhesive body 710 and the spacer 600 are disposed on the entire surface of the long side surface portion 311, the electrical insulation property between the first energy storage device 301 and the second energy storage device 302 can be further improved.

The spacer 600 includes the adhesive layers that adhered to the first energy storage device 301 and the second energy storage device 302 on both surfaces of the spacer 600. When the spacer 600 is adhered to the first energy storage device 301 and the second energy storage device 302 in this manner, the first energy storage device 301 and the second energy storage device 302 are fixed with the spacer 600 interposed therebetween. Thus, the first energy storage device 301 and the second energy storage device 302 can be more firmly fixed by the adhesion using the first adhesive body 710 and the adhesion using the spacer 600, so that the vibration resistance or the impact resistance of the energy storage apparatus 10 can be improved.

The first energy storage device 301 and the second energy storage device 302 can be temporarily fixed by the adhesion using the spacer 600. In particular, when the adhesive layer included in the spacer 600 is made of a pressure sensitive adhesive, curing of the first adhesive body 710 is not required to be waited for in adhering the first energy storage device 301 and the second energy storage device 302 using the first adhesive body 710, and the first energy storage device 301 and the second energy storage device 302 can be easily adhered to. Thus, the configuration that can improve the vibration resistance or the impact resistance of the energy storage apparatus 10 can be easily implemented.

The first adhesive body 710 is disposed in the concave part 311a which is formed at the middle portion of the surface (long side surface portion 311) opposite to the second energy storage device 302 in the first energy storage device 301. When the first adhesive body 710 is disposed in the concave part 311a at the middle portion of the first energy storage device 301, the first energy storage device 301 and the second energy storage device 302 are adhered to in a well-balanced manner, so that the vibration resistance or the impact resistance of the energy storage apparatus 10 can be improved.

The middle portions of the first energy storage device 301 and the second energy storage device 302 are likely to swell. When the concave part 311a is formed in the middle portion of the first energy storage device 301, a decrease in frictional force between the inner surface of the case 310 and the electrode assembly 350 can be prevented in the middle portion even when the middle portion swells. Thus, the movement of the electrode assembly 350 in the case 310 of the first energy storage device 301 can be prevented, so that the vibration resistance or the impact resistance of the energy storage apparatus 10 (first energy storage device 301) can be improved. Furthermore, when the first adhesive body 710 is disposed in the concave part 311a at the middle portion of the first energy storage device 301, even when the middle portions of the first energy storage device 301 and the second energy storage device 302 are about to swell, the first adhesive body 710 presses the middle portion, so that the swell of the middle portion can be prevented.

The energy storage unit 12 includes the end member 400 and the second adhesive body 720 that adheres to the end member 400 and the first energy storage device 301. As described above, when the end member 400 and the first energy storage device 301 are adhered using the second adhesive body 720, the movement of the first energy storage device 301 with respect to the end member 400 is restrain, so that the vibration resistance or the impact resistance of the energy storage apparatus 10 can be improved.

When the end member 400 and the first energy storage device 301 are adhered using the second adhesive body 720, the member (such as a side plate) that fixes the end member 400 to the first energy storage device 301 is not required to be disposed, so that the number of components can be reduced. Furthermore, when the end member 400 is adhered to the first energy storage device 301, the end member 400 can be reinforced and deformation of the end member 400 can be prevented. Accordingly, the miniaturization, weight, cost, and the like of the energy storage apparatus 10 can be attempted.

Because the first adhesive body 710 and the second adhesive body 720 are also disposed on the joint portion 310a of the long side surface portion 311, even when the case 310 is about to swell, the joint portion 310a is protected by the first adhesive body 710 and the second adhesive body 720, and damage to the joint portion 310a is prevented.

The fixing member 800 (810, 820 and 830) that fixes the energy storage unit 12 and the outer case 11 is disposed between the energy storage unit 12 and the outer case 11. When the energy storage unit 12 and the outer case 11 are fixed using the fixing member 800, the movement of the energy storage unit 12 (the first energy storage device 301, the second energy storage device 302, and the like) in the outer case 11 is prevented, so that the vibration resistance or the impact resistance of the energy storage apparatus 10 can be improved. When the energy storage unit 12 and the outer case 11 are fixed, the damage such as deformation or breakage of the bus bar that connects the energy storage device 300 in the energy storage unit 12 and the external terminal 210 attached to the outer case 11 can be prevented.

Because the fixing member 800 is the adhesive, the member (bolt or the like) for the fixing is not required to be disposed, and the number of components can be reduced. Thus, the miniaturization, weight, cost, and the like of the energy storage apparatus 10 can be attempted. Because the fixing member 800 has the electrical insulation property, conduction between the energy storage devices 300 of the energy storage unit 12 through the fixing member 800 and conduction between the energy storage devices 300 and another conductive member can be prevented.

In the above description, the effect exhibited by the concave part 311a of the first energy storage device 301 is similarly applied to the concave part 311a of the second energy storage device 302. The same applies to other energy storage devices 300.

[5 Description of Modifications]

(First Modification)

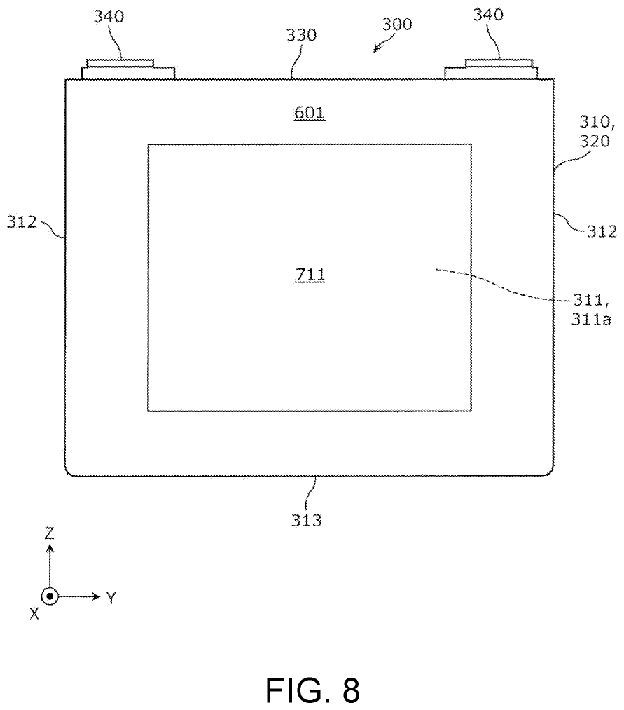

A first modification of the embodiment will be described. FIG. 8 is a front view illustrating a configuration in which a spacer 601 and a first adhesive body 711 are disposed on the energy storage device 300 according to the first modification of the embodiment. FIG. 8 is a view corresponding to FIG. 5.

As illustrated in FIG. 8, in the first modification, the spacer 601 and the first adhesive body 711 are disposed instead of the spacer 600 and the first adhesive body 710 in the embodiment. Because other configurations of the first modification are the same as those of the above embodiment, the detailed description will be omitted.

The spacer 601 is annularly disposed on the outer peripheral portion of the long side surface portion 311 of the energy storage device 300 so as to surround the periphery of the first adhesive body 711. As with the spacer 600 in the embodiment, the spacer 601 is the double-sided tape and has the electrical insulation property. The first adhesive body 711 is disposed inside the spacer 601, specifically, at the middle portion of the long side surface portion 311 of the energy storage device 300. That is, the first adhesive body 711 is disposed in the concave part 311a formed in the middle portion of the long side surface portion 311. As with the first adhesive body 710 in the embodiment, the first adhesive body 711 is an adhesive and has an electrical insulation property. As described above, the spacer 601 and the first adhesive body 711 are disposed at the positions not overlapping each other as viewed in the X-axis direction.

According to the energy storage apparatus of the first modification, the same effects as those of the embodiment can be obtained. In the first modification, the spacer 601 may not have an annular shape, but may have a linear shape extending in the Y-axis direction or the Z-axis direction or may have another shape. The first adhesive body 711 may also have a shape corresponding to the spacer 601. The shapes of the spacer and the first adhesive body disposed between two adjacent energy storage devices 300 are not particularly limited, but the spacer and the first adhesive body can be applied in any shape.

(Second and Third Modifications)

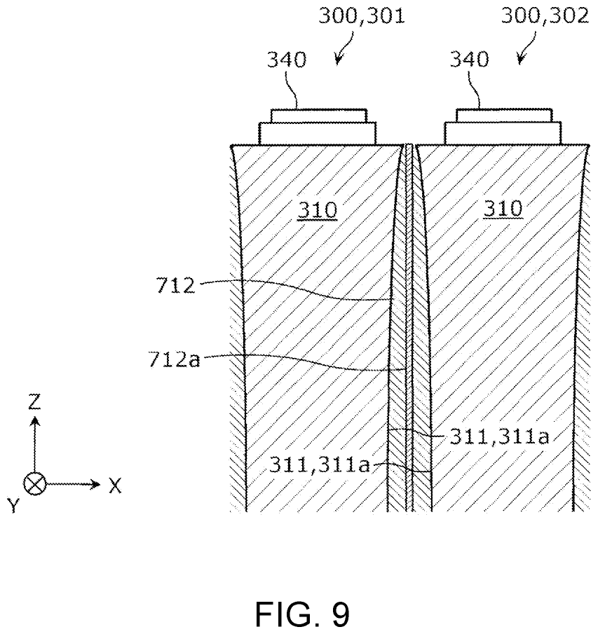

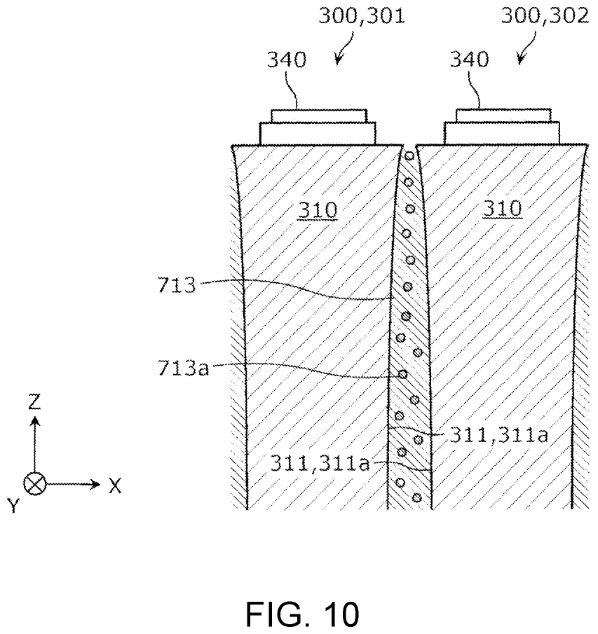

Second and third modifications of the embodiment will be described. FIG. 9 is a sectional view illustrating a configuration of a first adhesive body 712 according to the second modification of the embodiment, and FIG. 10 is a sectional view illustrating a configuration of a first adhesive body 713 according to the third modification of the embodiment. Specifically, FIG. 9 and FIG. 10 are figures corresponding to upper portions of the first energy storage device 301 and the second energy storage device 302 in FIG. 6.

As illustrated in FIG. 9, in the second modification, the first adhesive body 712 is disposed instead of the first adhesive body 710 of the above embodiment. As illustrated in FIG. 10, in the third modification, the first adhesive body 713 is disposed instead of the first adhesive body 710 of the above embodiment. In the second or third modification, the first adhesive bodies 712 or 713 are disposed instead of all the first adhesive bodies 710 in the above embodiment, but the first adhesive bodies 712 or 713 may be disposed instead of some of the first adhesive bodies 710. Because other configurations of the second and third modifications are the same as those of the above embodiment, the detailed descriptions will be omitted.

As illustrated in FIG. 9, the first adhesive body 712 includes a plate-like heat insulating material 712a inside. The heat insulating material 712a is disposed at the middle portion in the X-axis direction of the first adhesive body 712 over the entire first adhesive body 712 in the Y-axis direction and the Z-axis direction. The heat insulating material 712a is a flat plate-like (sheet-like) heat insulating material extending parallel to the YZ-plane. Examples of the heat insulating material include a heat conduction preventing sheet, a glass fiber sheet, and a ceramic plate, and the like. The heat insulating material 712a may be disposed inside the first adhesive body 712, but the position, size, and shape of the heat insulating material 712a in the first adhesive body 712 are not particularly limited.

As illustrated in FIG. 10, the first adhesive body 713 has a granular heat insulating material 713a inside. The heat insulating material 713a is a granular (particulate) heat insulating material scattered over the entire first adhesive body 713. Examples of the heat insulating material 713a include granular (particulate) heat insulating materials that can be used for the heat insulating material 712a described above. The heat insulating material 713a may be disposed inside the first adhesive body 713, but the position, size (particle size), and shape (sphere, ellipsoid, cube, rectangular parallelepiped, and the like) of the heat insulating material 713a in the first adhesive body 713 are not particularly limited.

According to the energy storage apparatuses of the second and third modifications, the same effects as those of the embodiment can be obtained. In particular, in the second and third modifications, the first adhesive body 712 or 713 includes the heat insulating material 712a or 713a inside, so that the heat insulating material 712a or 713a can be fixed together with the first energy storage device 301 and the second energy storage device 302. Thus, even when the heat insulating material 712a or 713a is disposed between the first energy storage device 301 and the second energy storage device 302, the vibration resistance or the impact resistance of the energy storage apparatus can be improved.

When the heat insulating material 712a or 713a is disposed inside the first adhesive body 712 or 713, the heat insulating material 712a or 713a can be easily disposed between the first energy storage device 301 and the second energy storage device 302. Thus, the first energy storage device 301 and the second energy storage device 302 can be thermally insulated with a simple configuration. Furthermore, using the heat insulating material 712a or 713a having high creep resistance, the creep resistance of the first adhesive body 712 or 713 can be improved.

(Other Modifications)

Although the energy storage apparatus of the embodiment (including the modifications) has been described above, the present invention is not limited to the embodiment. The embodiment disclosed herein is illustrative in all respects and is not restrictive, and the scope of the present invention includes all modifications within the meaning and scope equivalent to the claims.

In the above embodiment, the energy storage device 300 includes the concave parts 311a on both of the pair of long side surface portions 311 of the case 310. However, the concave part 311a may be formed on only one of the pair of long side surface portions 311. Any one of the plurality of energy storage devices 300 included in the energy storage unit 12 may not include the concave part 311a in both of the pair of long side surface portions 311.

In the embodiment, the spacer 600 or 601 (hereinafter, referred to as the spacer 600 or the like) and the first adhesive body 710, 711, 712 or 713 (hereinafter, referred to as the first adhesive body 710 or the like) are disposed all between two energy storage devices 300 disposed adjacently to each other. However, both or one of the spacer 600 and the first adhesive body 710 and the like may not be disposed between any two energy storage devices 300.

In the embodiment, the spacer 600 and the like and the first adhesive body 710 and the like are disposed on the entire surface of the long side surface portion 311. However, the spacer 600 and the like and the first adhesive body 710 and the like may not be disposed in a part of the long side surface portion 311. Even in this case, an insulating film (shrink tube or the like) that covers the outer surface of the case 310 is disposed around the case 310, so that the electrical insulation property of the energy storage device 300 can be ensured.

In the embodiment, the energy storage device 300 includes the concave part 311a at the middle portion of the long side surface portion 311 of the case 310. However, the concave part 311a may be formed at the end of the long side surface portion 311 instead of the middle portion of the long side surface portion 311. That is, the first adhesive body 710 and the like may be disposed in the concave part 311a at the end of the long side surface portion 311, and the spacer 600 and the like may be disposed in the middle portion of the long side surface portion 311.

In the embodiment, the spacer 600 or the like is the double-sided tape having the electrically insulating property and having the adhesive layers made of a pressure sensitive adhesive on both surfaces of the spacer 600. However, the spacer 600 or the like may have a hook-and-loop fastener structure or the like that is referred to as a magic tape (registered trademark) or a Berk mouth (registered trademark) tape and detachably adhered. In addition, the spacer 600 or the like may include the adhesive layer only on one side or have no adhesive layer on both sides. The adhesive layer of the spacer 600 or the like may include an adhesive other than the pressure sensitive adhesive. Furthermore, the spacer 600 or the like may be a conductive member having no electrical insulation property.

In the embodiment, the first adhesive body 710 and the like are the electrically insulating adhesive. However, the first adhesive body 710 or the like may be a conductive adhesive having no electrical insulation property, or may not be what is called the adhesive as long as it has an adhering function, and the material or the like thereof is not particularly limited. The same applies to the second adhesive body 720 and the fixing member 800 (810, 820, and 830). The fixing members 820, 830 may be members such as fillers having no bonding function.

In the embodiment, the pair of second adhesive bodies 720 is disposed with respect to the pair of end members 400. However, one or both of the pair of second adhesive bodies 720 may not be disposed. For example, one or both of the pair of end members 400 may not be disposed. In this case, the second adhesive body 720 may not be disposed on the side where the end member 400 is not disposed, but the fixing member 820 may fix (adhere) the outer case 11 and the energy storage device 300.

In the embodiment, the fixing member 810, the pair of fixing members 820, and the pair of fixing members 830 are disposed between the energy storage unit 12 and the outer case 11, and the energy storage unit 12 and the outer case 11 are fixed. However, the fixing member 800 in any one of the fixing members 810, the pair of fixing members 820, and the pair of fixing members 830 may not be disposed between the energy storage unit 12 and the outer case 11, but the energy storage unit 12 and the outer case 11 may be fixed. That is, at least one fixing member 800 out of the fixing member 810, the pair of fixing members 820, and the pair of fixing members 830 may be disposed between the energy storage unit 12 and the outer case 11. In other words, the fixing member 800 may fix at least one of the bottom surface portions 313 and the short side surface portions 312 of the plurality of energy storage devices 300 (the first energy storage device 301, the second energy storage device 302, and the like) and the pair of end members 400 to the outer case 11. Alternatively, no fixing member 800 may be disposed between the energy storage unit 12 and the outer case 11, and the energy storage unit 12 and the outer case 11 may not be fixed.

A form constructed by any combination of the components included in the embodiment and the modifications is also included in the scope of the present invention.

### INDUSTRIAL APPLICABILITY

The present invention can be applied to the energy storage apparatus including the energy storage device such as a lithium-ion secondary battery.

### DESCRIPTION OF REFERENCE SIGNS

10: energy storage apparatus
11: outer case
12: energy storage unit
100: outer case body
110: short side wall portion
120: long side wall portion
130: bottom wall portion
200: outer case lid
210: external terminal
300: energy storage device
301: first energy storage device
302: second energy storage device
310: case
310a: joint portion
311: long side surface portion
311a: concave part
312: short side surface portion
313: bottom surface portion
320: case body
330: case lid
340: electrode terminal
350: electrode assembly
351: end
360: current collector
400: end member
500: bus bar
600, 601: spacer
710, 711, 712, 713: first adhesive body
712a, 713a: heat insulating material
720: second adhesive body
800, 810, 820, 830: fixing member

1. An energy storage apparatus comprising an energy storage unit including a first energy storage device and a second energy storage device that are arranged in a first direction,
wherein the first energy storage device includes:
a concave part in which a surface of the first energy device, the surface opposite to the second energy storage device is recessed,
and
wherein the energy storage unit further includes:
a first adhesive body that is disposed in the concave part and adheres to the first energy storage device and the second energy storage device; and
a spacer that is disposed between the first energy storage device and the second energy storage device, the spacer being disposed at a position different from a position of the first adhesive body in a second direction intersecting with the first direction.

2. The energy storage apparatus according to claim 1, wherein the spacer includes adhesive layers that are adhered to the first energy storage device or the second energy storage device on both sides in the first direction.

3. The energy storage apparatus according to claim 1, wherein the concave part is formed such that a middle portion in the second direction of the surface of the first energy storage device is recessed.

4. The energy storage apparatus according to claim 1, wherein the energy storage unit further includes:
an end member disposed at a position where the first energy storage device is sandwiched between the end member and the second energy storage device in the first direction; and
a second adhesive body that is disposed between the end member and the first energy storage device and adheres to the end member and the first energy storage device.

5. The energy storage apparatus according to claim 1, further comprising:
an outer case accommodating the energy storage unit; and
a fixing member fixing the energy storage unit and the outer case.

6. The energy storage apparatus according to claim 1, wherein the first adhesive body includes a heat insulating material inside.
